(19) United States
(12) Patent Application Publication
(10) Pub. No.: US 2024/0202876 A1
(43) Pub. Date: Jun. 20, 2024

(54) Object Insertion via Scene Graph

(71) Applicant: Adobe Inc., San Jose, CA (US)

(72) Inventors: Tripti Shukla, Lucknow (IN); Kuldeep Kulkarni, Ilkal (IN); Paridhi Maheshwari, Bhopal (IN)

(73) Assignee: Adobe Inc., San Jose, CA (US)

(21) Appl. No.: 18/067,989

(22) Filed: Dec. 19, 2022

(51) Int. Cl. G06T 5/50; G06V 10/82; G06V 20/70

(52) U.S. Cl. CPC G06T 5/50; G06V 10/82; G06V 20/70; G06T 2207/20221

(57) ABSTRACT

Techniques are described for object insertion via scene graph. In implementations, given an input image and a region of the image where a new object is to be inserted, the input image is converted to an intermediate scene graph space. In the intermediate scene graph space, graph convolutional networks are leveraged to expand the scene graph by predicting the identity and relationships of a new object to be inserted, taking into account existing objects in the input image. The expanded scene graph and the input image are then processed by an image generator to insert a predicted visual object into the input image to produce an output image.

### BACKGROUND

Computing systems provide users with a variety of functionality for editing digital graphics, such as generating digital graphics, manipulating visual attributes of digital graphics, and so forth. For instance, some computing systems enable users to insert visual objects into digital graphics. Conventional systems for inserting visual objects into digital graphics, however, experience a number of drawbacks. For instance, to insert a visual objects into a digital image, some conventional systems utilize knowledge of a 3D geometry of the digital image, ambient lighting, shape and surface reflectance of an object, and render a new digital image with this information. Such systems may experience limitations in image quality and resource efficiency (e.g., for processing and memory resources), such as due to estimation of numerous physical variables to implement object insertion.

### SUMMARY

Techniques are described for object insertion via scene graph. In implementations, given an input image and a region of the image where a new object is to be inserted, the input image is converted to an intermediate scene graph space. In the intermediate scene graph space, graph convolutional networks are leveraged to expand the scene graph by predicting the identity and relationships of a new object to be inserted, taking into account existing objects in the input image. The expanded scene graph and the input image are then processed by an image generator to insert a predicted visual object into the input image to produce an output image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ object insertion via scene graph as described herein.

FIG. 2 depicts an example system for object insertion via scene graph in accordance with one or more implementations.

FIG. 3 depicts an example system for object insertion via scene graph in accordance with one or more implementations.

FIGS. 4 and 5 depict example implementations of a scene graph and an expanded scene graph.

FIG. 6 depicts an example implementation of an image generator module that is utilized as part of a system to insert an object into an input image.

FIG. 7 depicts a flow chart describing an example method for object insertion via scene graph.

FIG. 8 illustrates an example system that includes an example computing device that is representative of one or more computing systems and/or devices that are usable to implement the various techniques described herein.

FIG. 9 illustrates an example system that includes an example computing device that is representative of one or more computing systems and/or devices that are usable to implement the various techniques described herein.

### DETAILED DESCRIPTION

### Overview

To overcome the challenges to object insertion into digital images presented in conventional graphics systems, object insertion via scene graph is leveraged in a digital medium environment. For instance, to mitigate the challenges of limitations on image quality and excessive burden on system resources experienced when attempting to insert objects using conventional systems, the described techniques leverage existing inter-object relationships for existing objects in an image to features and relationships of objects to be inserted.

In implementations, given an input image and a region of the image where a new object is to be inserted, the input image is converted to an intermediate scene graph space. In the intermediate scene graph space, graph convolutional networks are leveraged to expand the intermediate scene graph by predicting the identity and relationships of a new object to be inserted, taking into account existing objects in the input image. The expanded scene graph and the input image are then processed by an image generator to insert a predicted visual object into the input image to produce an output image.

Accordingly, the described implementations leverage a richer representation of scene graphs defined by not only the object nodes but also the relationships between object nodes defined by the edges of the scene graph. A scene graph is expanded by identifying an object class for a missing node into which an object is to be inserted, and by predicting relationship classes between the missing node and the other existing nodes. In this way predicting the class for the missing node and a corresponding object for insertion is performed more accurately and produces higher quality in painted images with a plausible object inserted than is experienced with conventional systems.

For instance, object inpainting into an image is accomplished through object insertion as a three-stage modular process: scene graph expansion, object generation based on expanded scene graph, and image generation based on the generated object and an input image into which the generated object is inserted. Further, the object label of the missing node and its relationship with the other existing nodes are discovered through a scene graph expansion that is solved using a graph convolution network. The graph expansion results in both a semantic label and associated features for a predicted object to be inserted.

Accordingly, the described techniques provide accurate and efficient ways for inserting objects into images that produce higher quality images than conventional systems, and experience reduced computational system resource usage.

### Example Environment

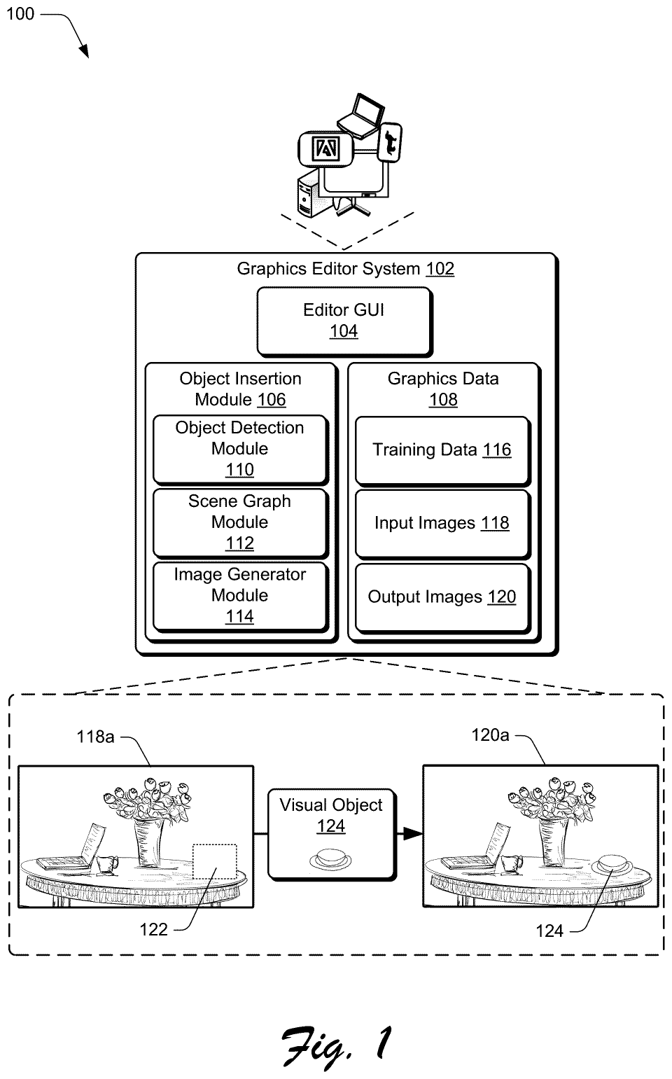

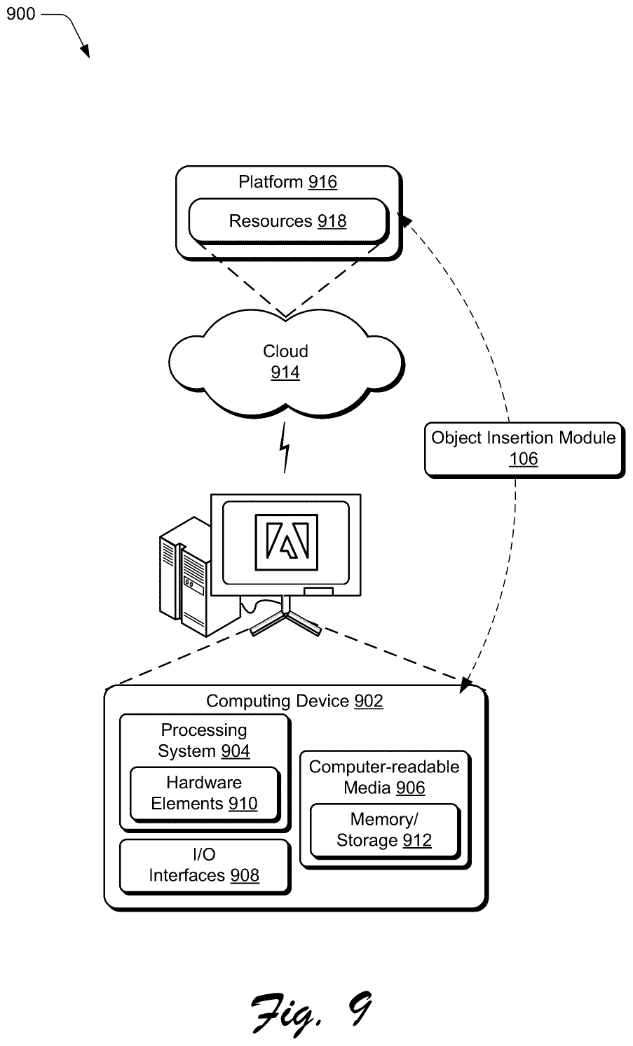

FIG. 1 is an illustration of an environment 100 in an example implementation that is operable to employ object insertion via scene graph as described herein. The illustrated environment 100 includes a graphics editor system 102 that is operable to perform various graphics editing operations, such as editing and creating digital images. Examples of computing devices that are used to implement the graphics editor system 102 include a desktop computer, a server device, multiple interconnected computing devices, and so forth. Additionally, the graphics editor system 102 is implementable using a plurality of different devices, such as multiple servers utilized by an enterprise to perform operations “over the cloud” as further described in relation to FIG. 9.

The graphics editor system 102 includes various functionality and data that enables aspects of object insertion via scene graph including an editor graphical user interface (GUI) 104, an object insertion module 106, and graphics data 108. The editor GUI 104 represents functionality that enables users to interact with the graphics editor system 102, such as to invoke functionality of the graphics editor system 102 and to view output of the graphics editor system 102. The object insertion module 106 represents functionality to perform techniques for object insertion via scene graph such as detailed herein. For instance, to enable the described techniques, the object insertion module 106 includes an object detection module 110, a scene graph module 112, and an image generator module 114. Further details concerning operation of the object insertion module 106 and its various functionality are discussed in detail below.

The graphics data 108 represents different types of data that is stored and/or generated by the graphics editor system 102, including training data 116, input images 118, and output images 120. According to implementations, the object insertion module 106 utilizes different machine learning functionality (e.g., different instances and types of neural networks) to perform aspects of object insertion via scene graph. Accordingly, the graphics editor system 102 utilizes the training data 116 to train functionality of the object insertion module 106.

The input images 118 represent images (e.g., digital images) into which visual objects are insertable by the object insertion module 106. In at least some implementations instances of the input images 118 include missing portions that are fillable by the object insertion module 106 with visual objects. The output images 120 represent instances of the input images 118 that are processed by the object insertion module 106 via insertion of visual objects.

For example, consider that a user interacts with the graphics editor system 102 and selects an input image 118a. The object insertion module 106 processes the input image 118a and identifies a region 122 of the input image 118a into which a visual object is to be inserted. In at least one implementation the region 122 represents a missing portion of the input image 118, such as a masked region of the input image 118a. Accordingly, the object insertion module 106 performs further processing on the input image 118a to identify existing visual features of the input image 118a, generate a visual object 124 based at least in part on the existing visual features, and insert the visual object 124 into the region 122 of the input image 118a to generate an output image 120a. Examples of detailed aspects of operations implemented by the object insertion module 106 to process the input image 118a and generate the output image 120 are presented below.

Having considered an example environment and system, consider now a discussion of some example details of the techniques for object insertion via scene graph in a digital medium environment in accordance with one or more implementations.

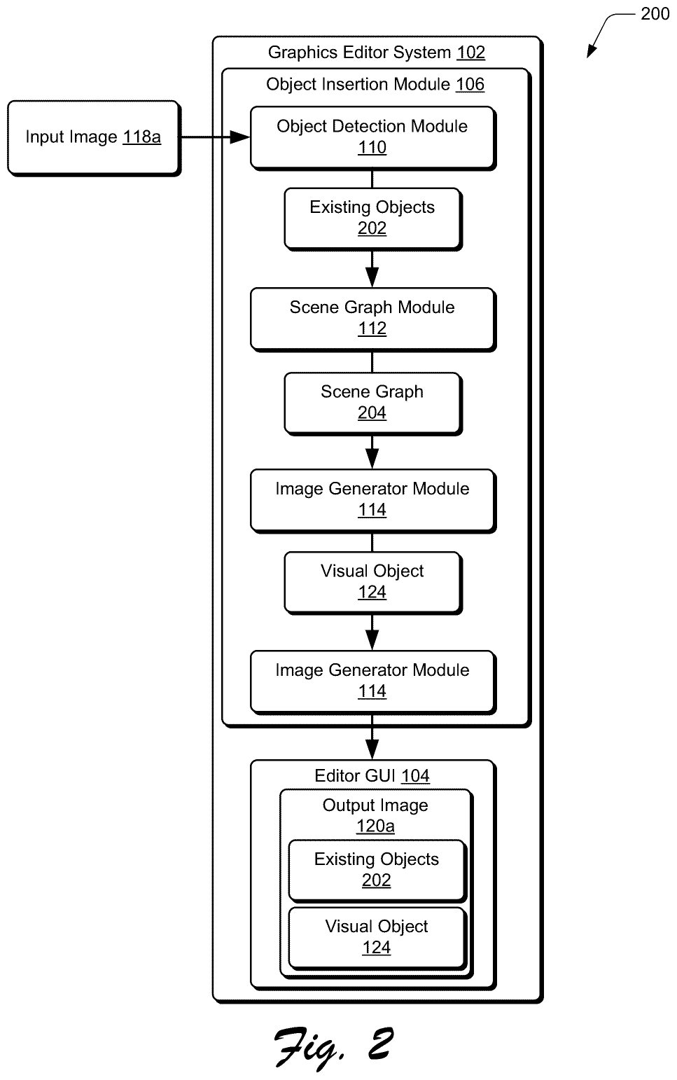

FIG. 2 depicts an example system 200 for object insertion via scene graph in accordance with one or more implementations. The system 200 incorporates features of the environment 100 and is operable within the context of the environment 100. In the system 200 the object detection module 110 receives the input image 118a and processes the input image 118a to detect existing objects 202. The existing objects 202, for instance, represent visual objects that are present within the input image 118a. The scene graph module 112 processes the input image 118a and the existing objects 202 to generate a scene graph 204. As further detailed below, the scene graph 204 describes identities of the existing objects 202 and relationships (e.g., semantic and positional relationships) of the existing objects 202 and the region 122 within the input image 118a.

Further to the system 200, the image generator module 114 processes the scene graph 204 to generate the visual object 124 for insertion into the input image 118a. The image generator module 114, for example, utilizes visual features and relationships of the existing objects 202 described by the scene graph 204 to generate the visual object 124. The image generator module 114 takes the visual object 124 and inserts the visual object 124 into the input image 118 to generate the output image 120a. For example, the image generator module 114 inserts the visual object 124 into a region of the input image 118a, such as a masked region of the input image 118, to generate the output image 120a. The graphics editor system 102 outputs the output image 120a including the existing objects 202 and the inserted visual object 124, such as using the editor GUI 104.

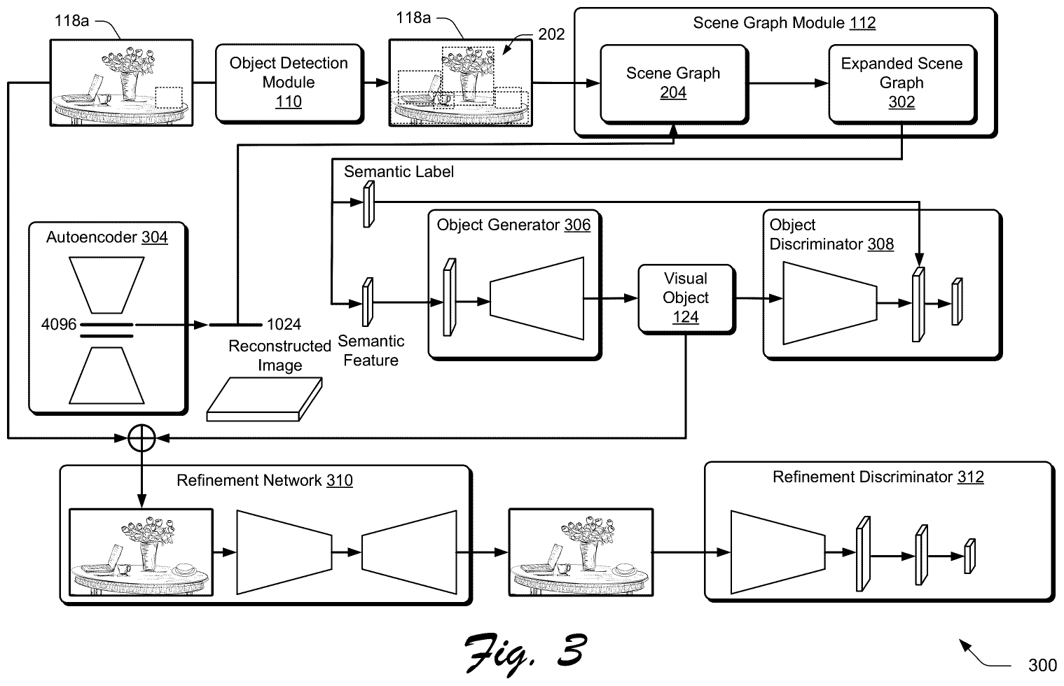

FIG. 3 depicts an example system 300 for object insertion via scene graph in accordance with one or more implementations. The system 300 incorporates features of the environment 100 and is operable within the context of the environment 100. In at least one implementation, the system 300 represents a detailed implementation of the system 200.

In the system 300, the object detection module 110 takes the input image 118a as input and performs object detection to recognize the existing objects 202 in the input image 118a, such as described above. The scene graph module 112 processes the input image 118a and the existing objects 202 to generate the scene graph 204. Further, the scene graph module 112 processes the scene graph 204 to generate an expanded scene graph 302.

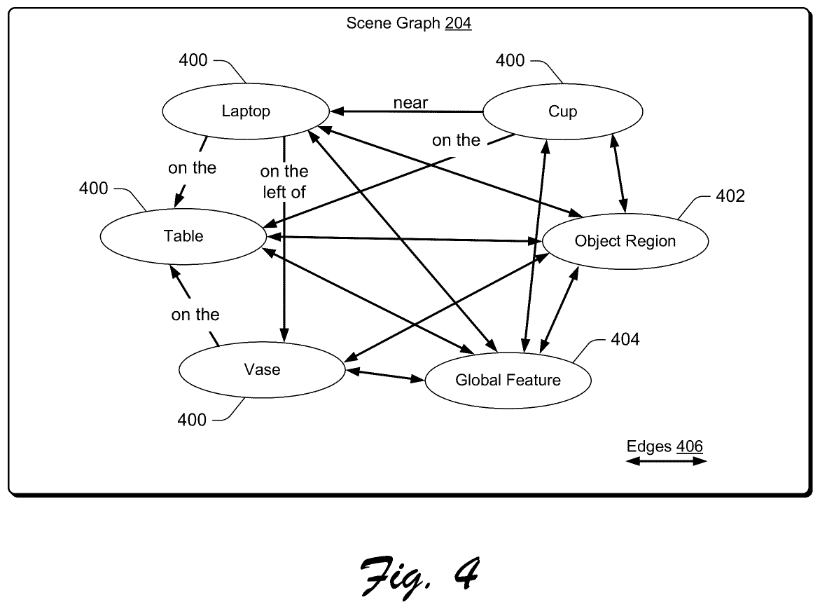

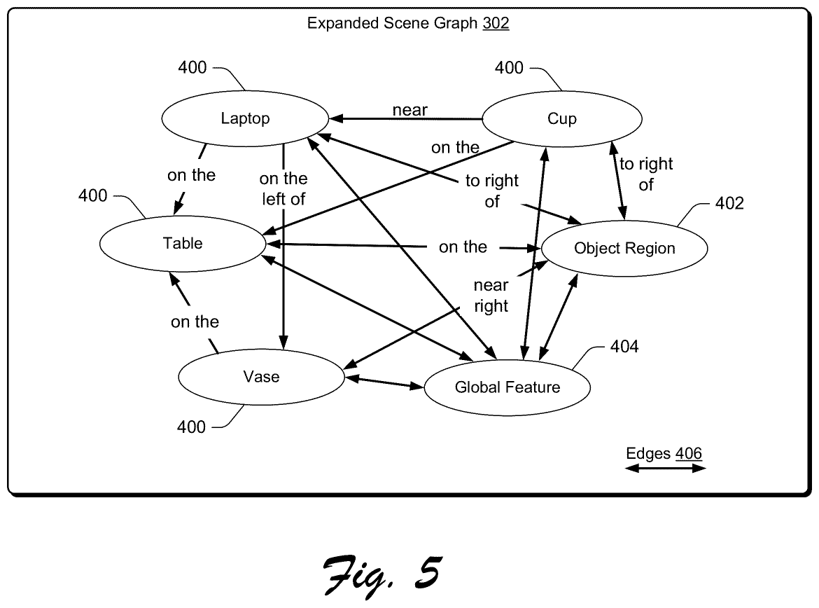

FIGS. 4 and 5 depict example implementations of the scene graph 204 and the expanded scene graph 302, respectively. The scene graph 204 includes nodes 400 that represent different instances of existing objects 202 from the input image 118a. As illustrated, the nodes 400 include labels that identify each existing object, e.g., “table,” “cup,” “laptop,” and “vase.” Further, the scene graph 204 includes a node 402 that represents an object to be inserted into the input image 118a at an object region, and a node 404 that represents a global feature for the input image 118a. The scene graph 204 also includes edges 406 that provide interrelation between the nodes of the scene graph 204. The edges 406, for instance, describe semantic and/or positional relationships of objects represented by the nodes 400. The expanded scene graph 302 expands the scene graph 204 to obtain an object feature for the node 402 as well as relationships (e.g., semantic and/or positional relationships) of the node 402 with the nodes 400.

Returning to the system 300, for the input image I (e.g., the input image 118a), a scene graph G is obtained as represented by G=(V, E)—a set of vertices V⊆ [symbol] and directed, labeled edges 406 E ⊆{(u, e, v)|u, v ∈ [symbol] , u≠v, e ∈ [symbol] that connect pairs of objects (e.g., nodes 400, 402) in V. Here, [symbol] is the set of distinct objects found in the input image I and [symbol] is the set of unique relationships between the objects. Further, G is made of <subject, predicate, object> triples such as<cat, on, bed> or <man, driving, car> where objects such as ‘cat’, ‘bed’, ‘man’, ‘car’ are examples for object nodes ∈V and ‘on’, ‘driving’ ∈E are examples for relationships connecting the nodes. In addition, an autoencoder 304 is trained to represent the input image I. A loss function for training the autoencoder 304 is given by

$${L}_{A E} = \frac{1}{N} {\sum }_{i = 1}^{N} {‖ {I}_{g} - {I}_{t} ‖}_{2}^{2} ,$$

where I_{g} is the ground truth image and Iₜ is the output from the autoencoder 304.

Further, a global feature of dimension 1024 is obtained for the input image I by tapping into an intermediate layer of the autoencoder 304 and then downsizing it to 300 dimensions using a fully connected network. Two additional nodes are also created, the node 404 that encodes an image-level global feature of the input image I and the node 402 that corresponds to an object to be inserted into the input image I, e.g., a missing object. The nodes 402, 404 are connected to the nodes 400 in the scene graph G to obtain the expanded scene graph 302, e.g., an initial expanded graph G₁. To obtain a feature representation of dimension 300 for a particular node of the scene graph 204, a text string corresponding to the semantic label of a corresponding object is converted, such as using GloVe embedding. Further, to obtain a feature representation of an edge of the scene graph 204, the GloVe embeddings for words in the triplet corresponding to the relationship defining the edge are averaged. Accordingly, edges in the scene graph 204 are represented by a feature dimension of 300.

Further to the system 300, the scene graph 204 is expanded to generate the expanded scene graph 302 in such a way that the expanded scene graph 302 describes an object feature the node 402 (e.g., an object to be inserted) as well as the relationships of the node 402 with the nodes 400 for existing visual objects 202. For instance, a graph convolutional network (GCN) takes in an initial expanded scene graph G₁ to obtain the final expanded scene graph Gₑ defined by features for each node and each relationship in the expanded scene graph 302. The GCN, for instance, is implemented by the scene graph module 112. Accordingly, each layer of the GCN performs message aggregation by passing information along the edges of the expanded scene graph 302 and learns updated features for nodes 400 and edges 406.

An object classifier head is also implemented on top of the features of the node 402. The output of the object classifier head is a probability score vector over the possible object classes and is compared with the one-hot vector for an object class of the node 402 using the cross-entropy loss. Further, a relationship classifier head is implemented on top of the features of the outgoing edges from the node 402. Each output of the relationship classifier head corresponds to one particular edge and computes a probability distribution over the possible relationship classes. To identify those edges that are not required, an additional class is included called “background.” Thus, the GCN is trained with the following loss function:

$${L}_{G C N} = \frac{1}{N} {\sum }_{i = 1}^{N} 𝒞ε ( {ℋ}_{o} ( f ( {x}_{i} ) ) , {o}_{i} + \frac{1}{N} {\sum }_{i = 1}^{N} {\sum }_{j = 1}^{{R}_{i}} 𝒞ε ( {ℋ}_{r} ( {g}_{j} ( {x}_{i} ) ) , {r}_{ij} ) ,$$

where xᵢ is the embedding of the i^{th} image in G₁, f is the series of the graph convolutional layers that operate on the graph, oᵢ is the one-hot representation for the ground-truth object class of the missing object, rᵢⱼ is the one-hot representation for the ground-truth relationship class for the j^{th} edge in the i^{th} image. [symbol] ᵣ and [symbol] ₒ are the multi-layer perceptrons defining the relationship and the object head respectively, while [symbol] is the cross-entropy loss function.

Further to the system 300, an object generator 306 (including an object discriminator 308) generates object images for an object to be inserted (e.g., the visual object 124) and inserts the objects into an input image, and a refinement network 310 (including a refinement discriminator 312) performs visual enhancement on the input image and the inserted object to generate an output image, e.g., the output image 120a. In implementations the object generator 306 and the refinement network 310 are implemented by the image generator module 114.

In example operation the object generator 306 generates object images of size 64×64. An object image is then resized using bi-linear interpolation and inserted into a region (e.g., a masked region) of the input image 118a. The refinement network 310 operates on images of size 256×256, enhancing the initial result. In implementations the object generator 306 is based on conditional generative adversarial network (GAN), taking features and class labels as input. Using the GAN an input feature vector and a class label are projected to higher convolutional neural network (CNN) layers through conditional instance normalization. Further, instance normalization and ReLU are used in the layers of the object generator 306. For the GAN loss, two discriminators are used; the object discriminator 308 for the object and the refinement discriminator 308 for the entire image. The object discriminator 308 takes the patch image of size 64×64 and the class label as input. A label projection architecture is used for class conditioning in the object discriminator. The refinement discriminator 312 differentiates on the entire image of size 256×256. In implementations both the object discriminator 308 and the refinement discriminator 312 consist of batchnorm and leaky-ReLU in every CNN layer. In the system 300, the symbol ⊕ denotes an operation that inserts the visual object 124 into the region 122.

Further, the object generator 306 and the refinement network 310 are trained together with the GAN loss and L1 loss. For the GAN loss, a hinge loss function is used given by Equation (2) (below), where G is the generator, D is the discriminator, x is a real image sample, and z is feature vector. Here, the object generator 306 tries to minimize (2), and the object discriminator 308 tries to maximize (2). The overall loss function for image generation is given by Equation (3), where L_{ObjGAN} and L_{RefGAN} are the GAN losses corresponding to object and refinement discriminator. L_{1Obj} and L_{1Ref} in (3) are the L1 norm loss for the object and refined image, given by Equation (4) where I_{g} is the generated image, Iₜ is the target image and N is the number of pixels. The values of λᵢ in (3) control the level of regularization and require careful selection. A higher value of λ₃ results in blurring and over-fitting, whereas a higher value of λ₁ and λ₂ often leads to model collapse.

$${min}_{G} {max}_{D} {L}_{GAN} = {E}_{x ∼ {𝒫}_{x}} [ max ( 0 , 1 - D ( x ) ) ] + {E}_{z ∼ {𝒫}_{z}} [ max ( 0 , 1 + D ( G ( z ) ) ) ] , \qquad ( 2 )$$

$${Loss}_{G} = {λ}_{1} {L}_{ObjGAN} + {λ}_{2} {L}_{RefGAN} + {λ}_{3} {L}_{1 Obj} + {λ}_{4} {L}_{1 Ref} \qquad ( 3 )$$

$${L}_{1} = \frac{1}{N} {‖ {I}_{g} - {I}_{t} ‖}_{1} \qquad ( 4 )$$

For training the system 300, we train a Mask-region based CNN (RCNN) model of the object detection module 110 on a training set that takes masked images as input. For each detected object, a 1028-dimension feature vector is constructed that encodes both semantic and spatial information. Features in a first 1024 dimensions are taken directly from the Mask-RCNN to account for the semantics, while features in the last four dimensions are the upper-left and lower-right coordinates of the detected bounding box that accounts for the spatial information of an object. This 1028-dimensional feature vector is further fed to the scene graph module 112 after projecting to 300 dimension. The autoencoder 304 network is trained with learning rate of 1e-3 for 100 epochs with a batch size of 64. The first 1024-dimension features are extracted from the autoencoder 304 as the global feature of the masked image and passed to the scene graph module 112.

For training the scene graph module 112 including a GCN, the GCN is trained with image level features obtained from the object detection module 110 and constituent word embeddings of relationships (edges) and objects (nodes) in the graph as input. The scene graph module 112 is trained for 100 epochs with a batch-size of 32 with different learning rates. In implementations a learning rate of 3e-4 for VG-9 dataset and 1e-4 for VG-20 are used. A node for an object (e.g., the visual object 124) to be inserted is initialized with a 1028-dimension vector with first 1024 dimensions as the Gaussian noise and the last four dimension as the top-left and bottom-right coordinates of the object. The input embedding size is 1028 and the output embeddings are of 1024 dimension.

The object generator 306 and the refinement network 310 are trained together for 200 epochs. The object generator 306 is trained on predicted semantic labels and the features from the GCN module. The refinement network 310 uses the generated object image and the input image to ensure semantic continuity on the full-scale image. The generator and discriminator are trained with Adam optimizer and learning rate of 1e-4. For the loss function, given by (3) above, λ₁=1.0, λ₂=1.0, λ₃=5.0 and λ₄=0.5 are used. In implementations the object detection module 110, the scene graph module 112, and the image generator module 114 are trained separately.

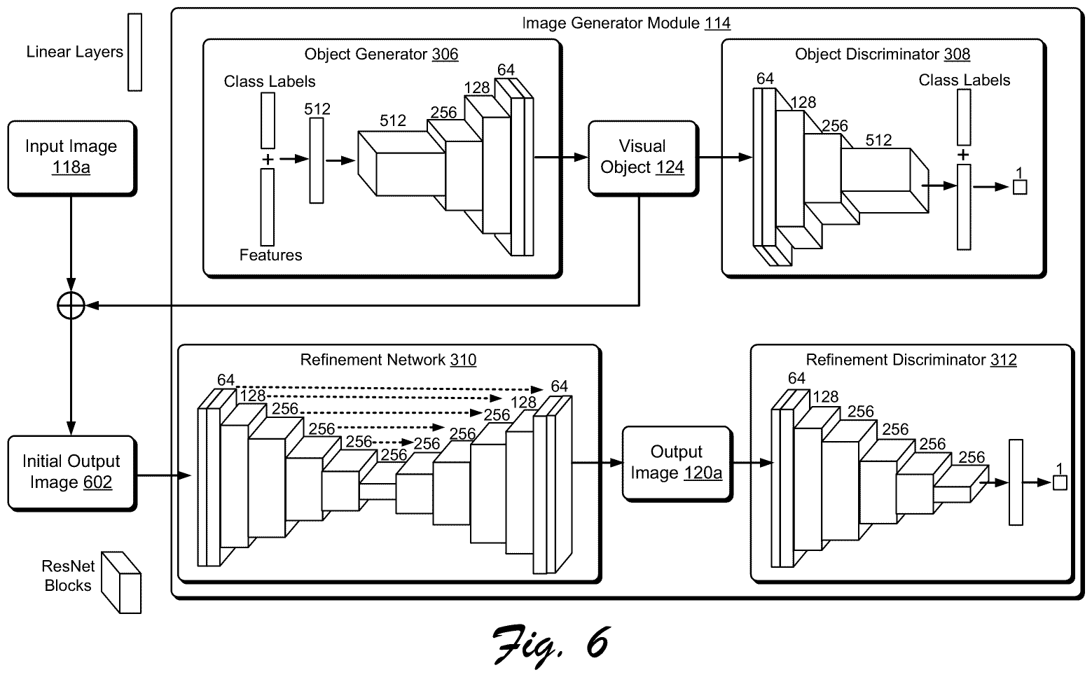

FIG. 6 depicts an example implementation of the image generator module 114 that is utilized as part of the system 300 to insert an object into an input image. The image generator module 114 depicts features of the object generator 306, the object discriminator 308, the refinement network 310, and the refinement discriminator 312. The object generator 306 inserts the visual object 124 into the input image 118a to generate an initial output image 602. The refinement network 310 processes the initial output image 602 to apply visual enhancement and generate the output image 120a.

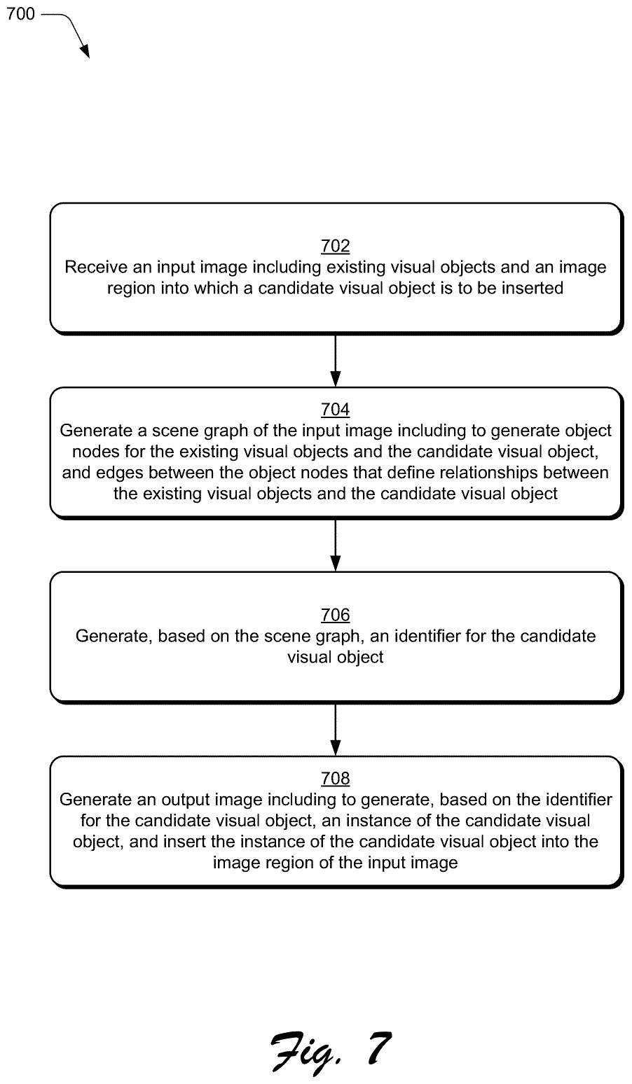

Having discussed some implementation details, consider now some example methods for object insertion via scene graph. FIG. 7 depicts a flow chart describing an example method 700 for object insertion via scene graph. In at least one implementation, the method is performed by the object insertion module 106 and/or the system 300, such as described above.

Step 702 receives an input image including existing visual objects and an image region into which a candidate visual object is to be inserted. The input image, for instance, represents a digital image consisting of pixels, e.g., a digital image in a pixel space. In at least one implementation the image region represents a blank region (e.g., a masked region) within the input image.

Step 704 generates a scene graph of the input image including generating object nodes for the existing visual objects and the candidate visual object, and edges between the object nodes that define relationships between the existing visual objects and the candidate visual object. For example, the scene graph module 112 generates the scene graph of the input image in a graph space.

Step 706 generates, based on the scene graph, an identifier for the candidate visual object. Detailed ways for utilizing a scene graph to generate an identifier and/or a label for a visual object to be inserted into an image are described above. Step 708 generates an output image including generating, based on the identifier for the candidate visual object, an instance of the candidate visual object, and inserting the instance of the candidate visual object into the image region of the input image.

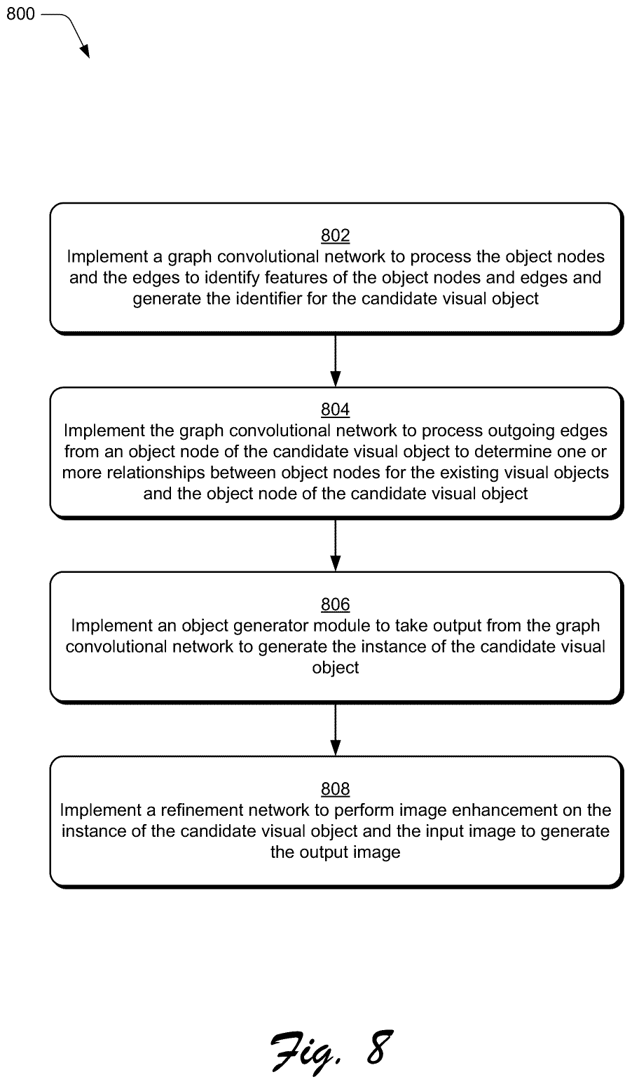

FIG. 8 depicts a flow chart describing an example method 800 for utilizing one or more machine learning networks as part of object insertion via scene graph. In at least one implementation, the method describes detailed ways for performing aspects of the method 700.

Step 802 implements a graph convolutional network to process the object nodes and the edges to identify features of the object nodes and edges and generate the identifier for the candidate visual object. The graph convolutional network, for instance, is implemented by the scene graph module 112. Step 804 implements the graph convolutional network to process outgoing edges from an object node of the candidate visual object to determine one or more relationships between object nodes for the existing visual objects and the object node of the candidate visual object.

Step 806 implements an object generator module to take output from the graph convolutional network to generate the instance of the candidate visual object. The object generator 306, for instance, utilizes the expanded scene graph 302 to generate the instance of the candidate visual object. Step 808 implements a refinement network to perform image enhancement on the instance of the candidate visual object and the input image to generate the output image. The refinement network 310, for instance, performs visual enhancement on an input image and an inserted visual object to generate an output image.

The example methods described above are performable in various ways, such as for implementing different aspects of the systems and scenarios described herein. For instance, aspects of the methods are implemented by the object insertion module 106. Generally, any services, components, modules, methods, and/or operations described herein are able to be implemented using software, firmware, hardware (e.g., fixed logic circuitry), manual processing, or any combination thereof. Some operations of the described methods, for example, are described in the general context of executable instructions stored on computer-readable storage memory that is local and/or remote to a computer processing system, and implementations include software applications, programs, functions, and the like. Alternatively or in addition, any of the functionality described herein is performable, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations are able to be performed in any order to perform a method, or an alternate method.

Having described example procedures in accordance with one or more implementations, consider now an example system and device that are able to be utilized to implement the various techniques described herein.

### Example System and Device

FIG. 9 illustrates an example system 900 that includes an example computing device 902 that is representative of one or more computing systems and/or devices that are usable to implement the various techniques described herein. This is illustrated through inclusion of the object insertion module 106. The computing device 902 includes, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that are be configured as processors, functional blocks, and so forth. This includes example implementations in hardware as an application specific integrated circuit or other logic device formed using one or more semiconductors. The hardware elements 910 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 906 is illustrated as including memory/storage 912. The memory/storage 912 represents memory/storage capacity associated with one or more computer-readable media. In one example, the memory/storage component 912 includes volatile media (such as random access memory (RAM)) and/or nonvolatile media (such as read only memory (ROM), Flash memory, optical disks, magnetic disks, and so forth). In another example, the memory/storage component 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that that is accessible to the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 910. For example, the computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supportable by various configurations of the computing device 902 and are not limited to the specific examples of the techniques described herein. This functionality is also implementable entirely or partially through use of a distributed system, such as over a “cloud” 914 as described below.

The cloud 914 includes and/or is representative of a platform 916 for resources 918. The platform 916 abstracts underlying functionality of hardware (e.g., servers) and software resources of the cloud 914. For example, the resources 918 include applications and/or data that are utilized while computer processing is executed on servers that are remote from the computing device 902. In some examples, the resources 918 also include services provided over the Internet and/or through a subscriber network, such as a cellular or Wi-Fi network.

The platform 916 abstracts the resources 918 and functions to connect the computing device 902 with other computing devices. In some examples, the platform 916 also serves to abstract scaling of resources to provide a corresponding level of scale to encountered demand for the resources that are implemented via the platform.

Accordingly, in an interconnected device embodiment, implementation of functionality described herein is distributable throughout the system 900. For example, the functionality is implementable in part on the computing device 902 as well as via the platform 916 that abstracts the functionality of the cloud 914.

What is claimed is:

1. A system comprising:
a memory component storing computer-executable instructions; and
a processing device coupled to the memory component and operable to execute the computer-executable instructions to:
receive an input image including existing visual objects and an image region into which a candidate visual object is to be inserted;
generate a scene graph of the input image including to generate object nodes for the existing visual objects and the candidate visual object, and edges between the object nodes that define relationships between the existing visual objects and the candidate visual object;
generate, based on the scene graph, an identifier for the candidate visual object; and
generate an output image including to generate, based on the identifier for the candidate visual object, an instance of the candidate visual object, and insert the instance of the candidate visual object into the image region of the input image.

2. The system of claim 1, wherein to generate the object nodes for the existing visual objects, the processing device is operable to execute the computer-executable instructions to generate labels identifying the existing visual objects.

3. The system of claim 1, wherein the relationships between the existing visual objects and the candidate visual object comprise one or more of semantic relationships or positional relationships of the existing visual objects within the input image.

4. The system of claim 1, wherein the processing device is operable to execute the computer-executable instructions to:
generate the scene graph to include a global feature node for the input image; and
generate the identifier for the candidate visual object based on the scene graph including the global feature node.

5. The system of claim 1, wherein the processing device is operable to execute the computer-executable instructions to generate, based on the scene graph, predicted visual features of the candidate visual object, and to generate the identifier for the candidate visual object based at least in part on the predicted visual features.

6. The system of claim 1, wherein to insert the instance of the candidate visual object into the image region, the processing device is operable to execute the computer-executable instructions to position the instance of the candidate visual object within the image region based on one or more positional relationships specified by one or more edges connected to an object node of the candidate visual object.

7. The system of claim 1, wherein the processing device is operable to execute the computer-executable instructions to implement a graph convolutional network to:
process the object nodes and the edges to identify features of the object nodes and edges and generate the identifier for the candidate visual object; and
process outgoing edges from an object node of the candidate visual object to determine one or more relationships between object nodes for the existing visual objects and the object node of the candidate visual object.

8. The system of claim 7, wherein the processing device is operable to execute the computer-executable instructions to implement:
an object generator module to take output from the graph convolutional network to generate the instance of the candidate visual object; and
a refinement network to perform image enhancement on the instance of the candidate visual object and the input image to generate the output image.

9. A method comprising:
receiving an input image in a pixel space, the input image including existing visual objects and an image region into which a candidate visual object is to be inserted;
generating a scene graph of the input image in a graph space, the scene graph including object nodes for the existing visual objects and the candidate visual object, and edges between the object nodes that define relationships between the existing visual objects and the candidate visual object;
generating, based on the scene graph, an identifier for the candidate visual object; and
generating an output image in a pixel space including generating, based on the identifier for the candidate visual object, an instance of the candidate visual object, and inserting the instance of the candidate visual object into the image region of the input image.

10. The method of claim 9, wherein generating the object nodes for the existing visual objects comprises generating labels identifying the existing visual objects.

11. The method of claim 9, wherein the relationships between the existing visual objects and the candidate visual object comprise one or more of semantic relationships or positional relationships of the existing visual objects within the input image.

12. The method of claim 9, further comprising:
generating the scene graph to include a global feature node for the input image; and
generating the identifier for the candidate visual object based on the scene graph including the global feature node.

13. The method of claim 9, further comprising generating, based on the scene graph, predicted visual features of the candidate visual object, and wherein generating the identifier for the candidate visual object is based at least in part on the predicted visual features.

14. The method of claim 9, wherein inserting the instance of the candidate visual object into the image region comprises positioning the instance of the candidate visual object within the image region based on one or more positional relationships specified by one or more edges connected to an object node of the candidate visual object.

15. The method of claim 9, further comprising implementing a graph convolutional network to perform operations including:
processing the object nodes and the edges to identify features of the object nodes and edges and generate the identifier for the candidate visual object; and
processing outgoing edges from an object node of the candidate visual object to determine one or more relationships between object nodes for the existing visual objects and the object node of the candidate visual object.

16. The method of claim 15, further comprising:
implementing an object generator module to take output from the graph convolutional network to generate the instance of the candidate visual object; and
implementing a refinement network to perform image enhancement on the instance of the candidate visual object and the input image to generate the output image.

17. A non-transitory computer-readable medium storing executable instructions, which when executed by a processing device, cause the processing device to perform operations comprising:
generating a scene graph of an input image including generating object nodes for existing visual objects of the input image, an object node for a candidate visual object to be inserted into the input image, and edges between the object nodes that define relationships between the existing visual objects and the candidate visual object; and
generating an output image by generating, based on the scene graph, an instance of the candidate visual object and inserting instance of the candidate visual object into the input image.

18. The non-transitory computer-readable medium of claim 17, wherein the operations further comprise:
receiving the input image in a pixel space, and converting the input image from the pixel space to a graph space to generate the scene graph with the object nodes for the existing visual objects and the candidate visual object, and the edges between the object nodes that define relationships between the existing visual objects and the candidate visual object.

19. The non-transitory computer-readable medium of claim 17, wherein the relationships between the existing visual objects and the candidate visual object comprise one or more of semantic relationships or positional relationships of the existing visual objects within the input image.

20. The non-transitory computer-readable medium of claim 17, wherein the operations further comprise:
generating, based on the scene graph, an identifier for the candidate visual object; and
generating the instance of the candidate visual object based at least in part on the identifier for the candidate visual object.
